(19) United States
(12) Patent Application Publication
(10) Pub. No.: US 2024/0035599 A1
(43) Pub. Date: Feb. 1, 2024

(54) Spade Flange Tool with Fluid Passage

(71) Applicant: Vital Containment Solutions Inc., Sarnia (CA)

(72) Inventors: Jody Tyler MINAKER, Sarnia (CA); Adam Richard CASE, Dashwood (CA)

(73) Assignee: Vital Containment Solutions Inc., Sarnia, ON (CA)

(21) Appl. No.: 18/255,930

(22) PCT Filed: Dec. 3, 2021
(86) PCT No.: PCT/CA2021/051731

§ 371 Date: Jun. 5, 2023

Related U.S. Application Data
(60) Provisional application No. 63/199,082, filed on Dec. 5, 2020.

(51) Int. Cl. F16L 23/00; F16L 55/07

(52) U.S. Cl. CPC F16L 23/006; F16L 55/07

(57) ABSTRACT

A spade flange tool comprises a spade portion and a handle portion, wherein the spade portion includes a well for collecting fluids and wherein the handle portion includes a drain, in fluid communication with the well, for draining fluids collected in the well. The spade flange tool described herein is particularly useful for safely and effectively draining waste fluid effluent from cleaning operations used in onsite cleaning of equipment in industrial plants, such as vessels, tanks, conduits, etc., having a flanged connection. The spade flange tool may also be used to introduce a pressurizing fluid into equipment having a flanged connection.

### CROSS REFERENCE TO PRIOR APPLICATIONS

This application claims priority under the Paris Convention to US Application No. 63/199,082, filed on Dec. 5, 2020. The entirety of such prior application is incorporated herein by reference.

### FIELD OF THE DESCRIPTION

The present description relates, in one aspect, to devices and methods for facilitating cleaning of industrial or chemical plant equipment, such as tanks, vessels, and the like. More particularly, the description relates to a spade flange tool having a fluid passage for use with flanged connections of such equipment.

### BACKGROUND

In industrial plants, such as chemical or petrochemical plants etc., it is common to incorporate reaction vessels, containment tanks and the like, which contain various components. Such components may be in any state, including liquid, solid, or gaseous states. Equipment of this sort is connected to other plant equipment by means of conduits as commonly known in the art. As also commonly known, connections between plant equipment are generally achieved by means of opposed flanges that are provided on the ends of the equipment being connected. For the present description, a connection comprising opposed flanges will be referred to as a “flanged connection”. As discussed further herein, opposed flange faces are bolted together, with a seal such as a gasket provided in between.

As also known in the art, and as discussed further herein, where flow through a flanged connection is to be blocked, a “spade flange” may be inserted within the connection between opposed flanges. A spade flange generally comprises a solid plate having a diameter sufficient to block the opening in the flange. The spade flange also typically includes a handle portion, which allows manipulation of the spade flange, such as during its installation and placement. Spade flanges are used to block flow between equipment at a flanged connection.

In practice, plant equipment, such as the tanks, vessels, conduits etc., as mentioned above must be cleaned. This serves to improve the lifespan of the equipment but also to address safety concerns particularly where flammable or toxic materials are involved. In a typical cleaning operation, after emptying the equipment in question, the flanged connection is separated, and the equipment is flushed with a cleaning fluid. A container is used to collect the effluent from the cleaning operation, which is then loaded into a waste tank provided on a truck or the like. The waste effluent is then transported to a disposal or treatment facility. Thereafter, the flanged connection is restored, and the equipment is returned to service.

In the known cleaning operations, it is common for the waste effluent to spilled onto the ground. This may occur due to overfilling of the container used to capture the effluent, or due to improper placement of such container. Such spillage poses a potential environmental hazard, particularly where the equipment being cleaned was used to contain toxic or otherwise environmentally polluting materials. The cleaning fluid itself may pose a further risk for environmental damage.

There exists a need, therefore, for an improved means of cleaning industrial equipment while minimizing the risk for environmental contamination as discussed above.

### SUMMARY OF THE DESCRIPTION

Generally, the present description provides a spade flange including a drain for providing a fluid outlet through flanged connections.

In one aspect, there is provided a spade flange tool comprising: a generally disc shaped spade portion having a diameter and a radially extending handle; a connecting block connected to the handle; the spade portion having a first face and a second face, the first face including a well, the well having a diameter that is less than the diameter of the spade portion; the handle including a drain extending there-through, the drain being in fluid communication with the well; the connecting block having a first end having an aperture adapted to receive the handle, and an opposed second end, having a bore, the bore being in fluid communication with the drain.

### BRIEF DESCRIPTION OF THE FIGURES

The features of certain embodiments will become more apparent in the following detailed description in which reference is made to the appended figures wherein:

FIG. 1 is a cross-sectional view of a typical flanged connection.

FIG. 2 is a top view of a spade flange as known in the art, the bottom side being identical.

FIG. 3 is a side view of a flanged connection including a spade flange.

FIG. 4 is a bottom view of a spade flange having a modification as known in the art.

FIG. 5 is a bottom view of a spade flange having a modification as known in the art.

FIG. 6 is a perspective of the spade flange of FIG. 5.

FIG. 7 is a perspective view of a modified spade flange according to an aspect of the description.

FIG. 8 is a top view of the spade flange of FIG. 7.

FIG. 9 is a side cross-sectional view of the spade flange of FIG. 8 taken through line 9-9.

FIG. 10 is a top perspective view of an attachment block according to an aspect of the description.

FIG. 11 is a side elevation of the attachment block of FIG. 10.

FIG. 12 is a bottom view of the attachment block of FIG. 10.

FIG. 13 is a top view of the attachment block of FIG. 10.

FIG. 14 is a front cross-sectional view of the attachment block of FIG. 10 taken through line 14-14 of FIG. 13.

FIG. 15 is a side cross-sectional view of the attachment block of FIG. 10 taken through line 15-15 of FIG. 13.

FIG. 16 is a top perspective view of the combined spade flange with attachment block.

FIG. 17 is top, front perspective view of a flanged connection incorporating a modified spade flange and connecting block as described herein.

FIG. 18 is a side elevation of the flanged connection of FIG. 17.

FIG. 19 is a top view of the flanged connection of FIG. 17.

### DETAILED DESCRIPTION

As used herein, the term “equipment” will be interpreted to mean components of an industrial plant, such as reaction vessels, holding tanks, piping, conduits, and other such components. In particular, the equipment considered herein comprises those that are joined with other components using flanges. Various such equipment will be known to persons skilled in the art.

As used herein, the “comprise”, “comprises”, “comprised” or “comprising” may be used in the present description. As used herein (including the specification and/or the claims), these terms are to be interpreted as open-ended terms and as specifying the presence of the stated features, integers, steps or components, but not as precluding the presence of one or more other feature, integer, step, component or a group thereof as would be apparent to persons having ordinary skill in the relevant art. Thus, the term “comprising” as used in this specification means “consisting at least in part of”. When interpreting statements in this specification that include that term, the features, prefaced by that term in each statement, all need to be present but other features can also be present. Related terms such as “comprise” and “comprised” are to be interpreted in the same manner.

The phrase “consisting essentially of” or “consists essentially of” will be understood as generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open-ended term, such as “comprising” or “including”, it will be understood that direct support should be afforded also to “consisting essentially of” language as well as “consisting of” language as if stated explicitly and vice versa. In essence, use of one of these terms in the specification provides support for all of the others.

The term “and/or” can mean “and” or “or”.

Unless stated otherwise herein, the articles “a” and “the”, when used to identify an element, are not intended to constitute a limitation of just one and will, instead, be understood to mean “at least one” or “one or more”.

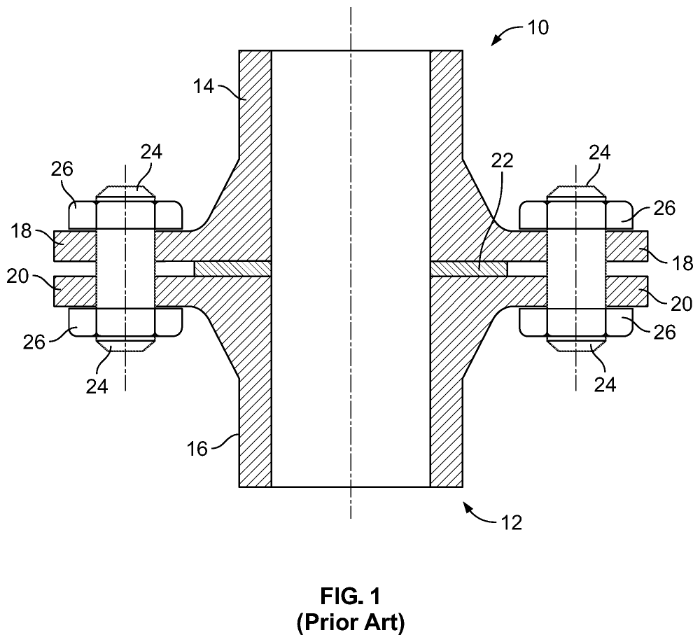

FIG. 1 illustrates a typical flanged connection, as is commonly known. The connection comprises opposed flange components, such as first flange component 10 and second flange component 12. Each flange component comprises a stem portion, 14 and 16, respectively, which are connected to equipment, such as conduits, pipe stems from vessels or tanks etc., or other such equipment. The stem portions are typically permanently joined to such equipment by welding etc. The stem portions have internal bores which allow fluid communication there-through. Each flange component 10, 12 also comprises a generally annular flange plate, 18, 20, respectively, which comprises a ring having a plurality of circumferentially spaced bolt holes. When forming the flanged connection, the flange plates 18 and 20 are placed in opposing arrangement with the respective bolt holes being aligned. An annular sealing element, such as a gasket 22, is positioned between the opposed flange plates. Bolts 24 are then inserted into the aligned bolt holes of the flange plates 18, 20. Nuts 26 are then provided on one or both ends of the bolts 24 and tightened, thereby urging the opposed flange plates together. When the flanged connection is completed in this manner, a fluid tight seal is formed between the respective flange components and fluid flows there-through without leakage.

As mentioned above, when a cleaning operation is to be performed, a flanged connection, such as shown in FIG. 1, is dismantled by removing the nuts 26 and separating the flange components. The flange component connected to the equipment being cleaned is not removed. Cleaning fluid is then introduced into the equipment being treated, and the waste effluent from the cleaning operation exits through the respective flange component. As described above, such fluid is then typically collected in a container or the like for subsequent removal by a disposal truck. As also described above, this known method has several deficiencies.

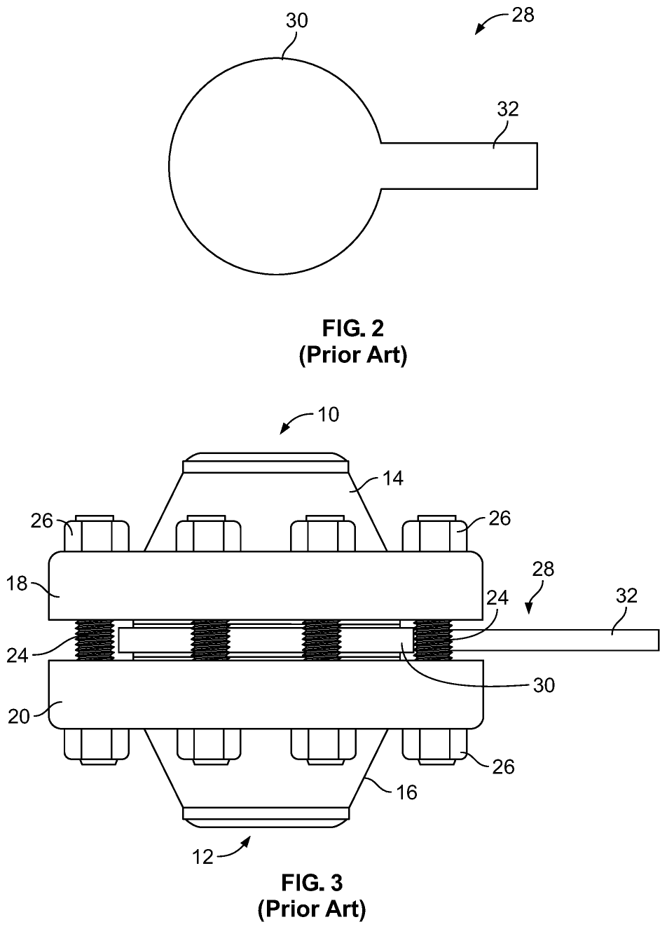

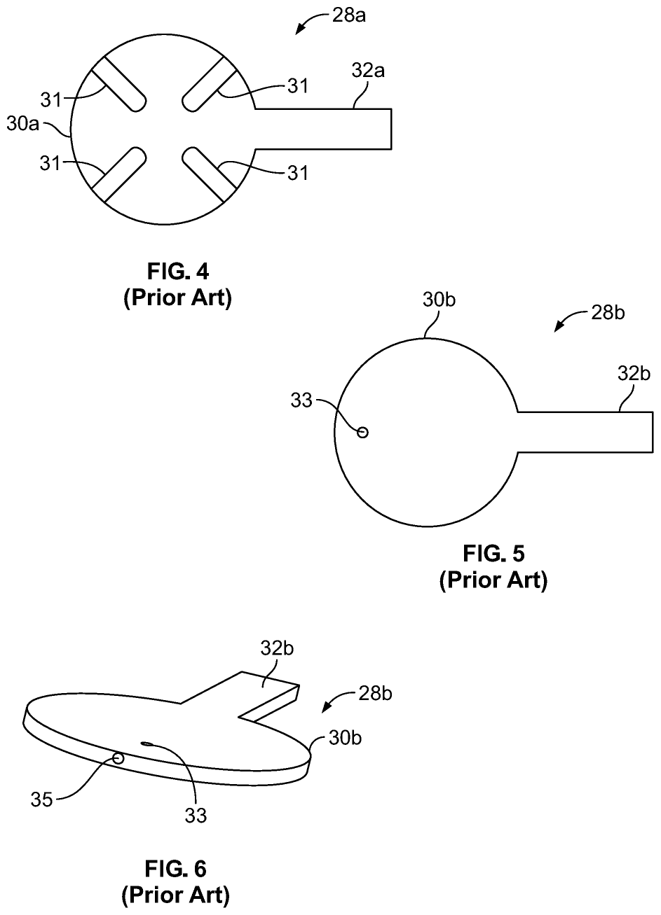

FIG. 2 illustrates a “spade flange” 28 as known in the art. Generally, such flanges comprise a plate-shaped “spade” portion 30 and a handle portion 32. A top view of the spade flange 28 is shown in FIG. 2. As will be known, the bottom side of the flange would be identical; however, FIGS. 4 and 5 illustrate alternate bottom views.

FIG. 3 illustrates a flanged connection having a spade flange as known in the art installed therein. Elements in FIG. 3 that are common to FIGS. 1 and 2 are identified with the same reference numerals. As shown, the spade flange 28 is positioned between the opposed flange plates, wherein the spade 30 is placed in a position to block the openings of the flange components 10 and 12. The handle 32 is used to position and/or manipulate the spade flange 28. Once in position, the flange components are reconnected using the bolts and nuts 26, as is commonly known. In this arrangement no fluid is passed through the flanged connection. As discussed above, spade flanges form a block at a flanged connection to prevent fluid communication between equipment. This allowed equipment to be serviced without dismantling the equipment connections and without the hazard of fluids and gases from the other equipment interfering with the equipment being serviced.

FIGS. 4 to 6 illustrate known variations of the spade flange as shown in FIGS. 2 and 3, wherein like elements are identified with like numbers but with the letter “a” or “b” added for clarity. FIG. 4 illustrates a spade flange 28a having radially extending grooves 31 on the spade portion 30a that serve to vent equipment opposite to equipment that is being serviced. As will be understood, the grooves 31 permit venting of gases or other fluids radially through the flanged connection and into the atmosphere. FIGS. 5 and 6 illustrates another variation of a spade flange 28b which includes a bleed or vent port 33 provided near the outer perimeter of the spade portion 30b, which, like the previously mentioned grooves 31, is provided on a side of the spade portion 30b opposite to the equipment being serviced. The bleed port is connected through a bore provided in the body of the spade portion 30b of the spade flange 28b to an outlet 35 on an outer perimeter of the spade portion 30b. Generally, the spade flange 28b of FIGS. 5 and 6 would be installed with the bleed port 33 positioned at the lowest point so that any liquids in the equipment facing the flange would be drained by gravity.

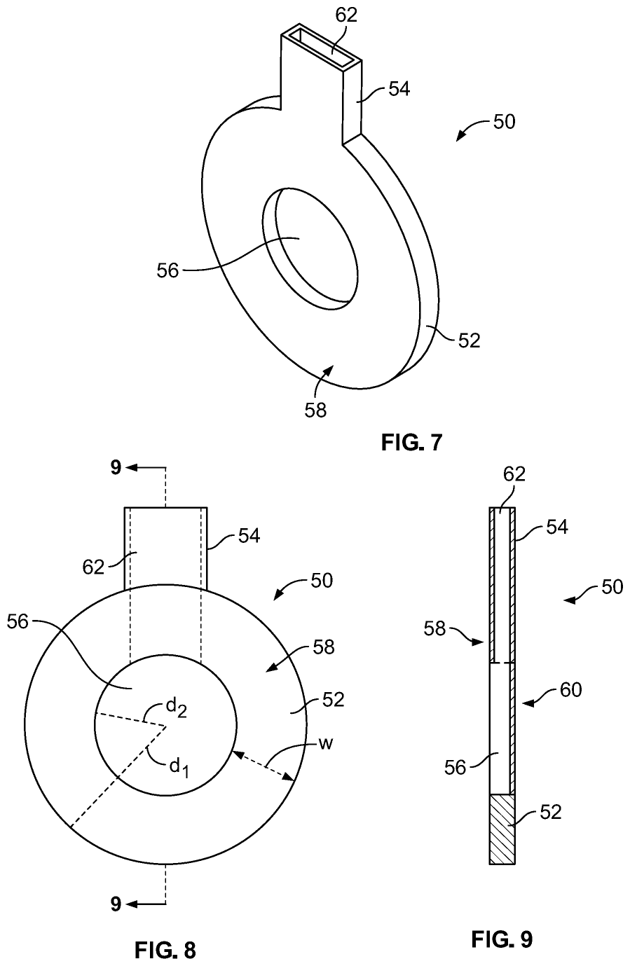

According to an aspect of the present description, there is provided a modified spade flange that is secured in the flanged connection in a similar manner as known spade flanges, but which allows fluid communication there-through. Such a modified spade flange, or modified spade flange device, is illustrated at 50 in FIGS. 7 to 9. As shown, the spade flange 50 comprises a generally plate-shaped spade, or spade flange portion 52 and a handle portion 54. The modified spade portion 52 includes a cavity, or well 56 on a first face thereof. The second face 60 of the spade flange 50, opposite the first face 58, will be understood to be generally flat. However, in some aspects, the second face 60 may, as known in the art, be provided with one or more radially extending grooves (as shown in FIG. 4) or a bleed port (as shown in FIGS. 5 and 6) that serve to vent to the atmosphere any fluids from the equipment facing the second face 60 of the spade flange. That is, the grooves or bleed port would be provided on a side of the spade flange that is opposite to the equipment that is being cleaned.

As shown in FIGS. 7-9, the handle 54 of the spade flange 50 described herein includes a drain 62 extending there-through. The drain 62 may be of any shape; however, as will be understood, to maximize fluid flow there-through, the drain 62 is preferably rectangularly shaped. In this way, the drain 62 occupies a larger portion of available volume of the handle 54. As would be understood, this preferred rectangular shape for the drain 62 is the result of the flat shape of the spade flange 50, which limits one dimension of the opening of the drain 62. The other limitation on the size of the drain 62 relates to the portion of the circumference of the spade flange portion 52 on which the drain 62 can be formed. In this regard, the drain is formed in the handle portion 54, which preferably is of a width that can be manually manipulated where needed. Further, the width of the handle 54 cannot be greater than the distance between adjacent flange bolts (as shown for example in FIGS. 1 and 3, and as discussed further below). Thus, in view of the limitation in thickness and width of the handle 54, the drain 62 extending there-through would assume a generally rectangular shape to maximize the volume of the drain 62.

The drain 62 extends into the well 56, thereby forming a fluid passage there-through.

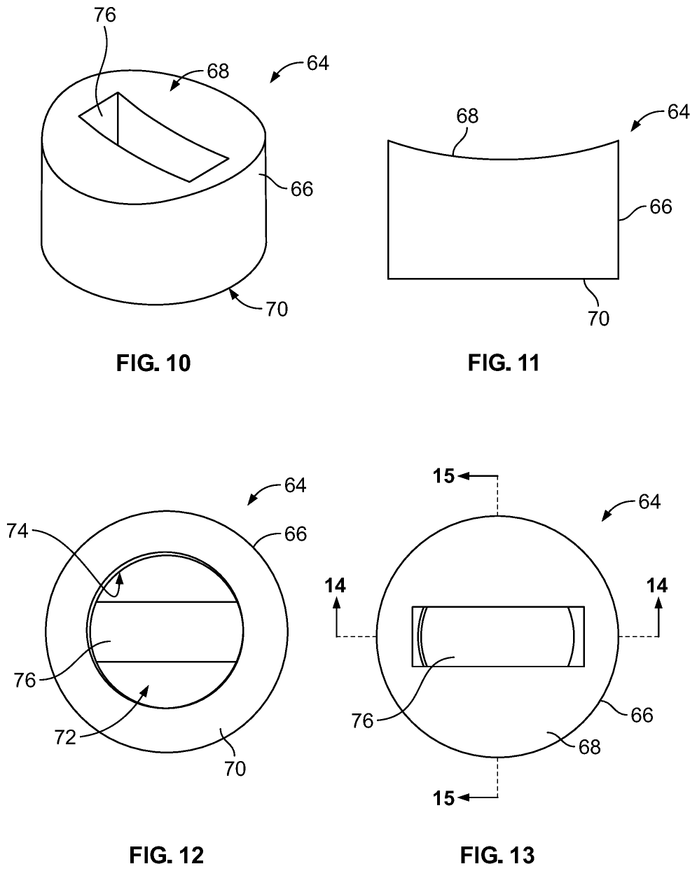

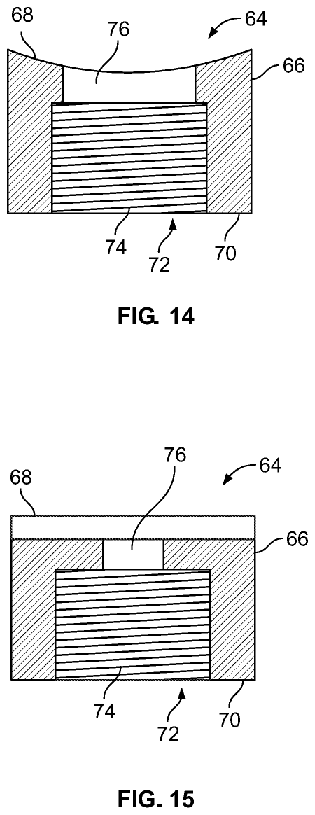

Another component of the modified spade flange described herein comprises an attachment block 64 that is illustrated in FIGS. 10-15. The block 64 comprises a body 66 that, in one preferred aspect, has a generally cylindrical shape. The block 64 includes a top end 68, a bottom end 70. The bottom end 70 of the block 64 includes a bore 72 that does not extend entirely through block 64. In one aspect, as illustrated in particular in FIGS. 12-15, the inner diameter 74 of the bore 72 is formed with thread. As described further below, such threaded bore is adapted to threadingly connect to a hose, pipe, or other such component.

As shown in FIGS. 10-15, the block 64 further includes an aperture 76 extending from the top end 68 and into the bore 72. The aperture 76 is adapted to receive the handle 54 of the spade flange 50. For this purpose, the aperture 76 will be understood to have the same general shape as the handle 54, such as, in one aspect, a generally rectangular shape, as described above. Thus, in the preferred aspect, the aperture 76 has a slot-like configuration adapted to receive the generally rectangular-shaped handle 54. It will also be understood that the aperture 76 will be sized to allow the handle 54 to extend there-through. In this way, it will be understood that a fluid channel is formed from the well 56 of the spade flange 50 into the bore 72 of the attachment block 64. Once arranged in this manner, the spade flange 50 and block 64 may be secured together such as by welding etc. In particular, the spade flange 50 and the block 64 are secured together in a sealed manner, whereby fluids entering the block 64 through the drain 62 of the handle are not leaked.

As shown particularly in FIGS. 10, 11, and 14, the top end 68 of the attachment block 64 is preferably provided with a curved surface. The purpose of such curvature is discussed below.

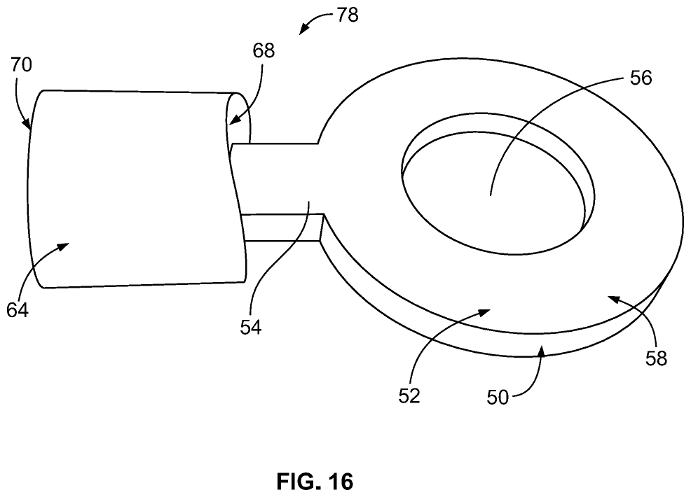

FIG. 16 illustrates the combined spade device 78 according to an aspect of the description, comprising the spade flange portion 52 and the attachment block portion 64. As noted in FIG. 16, the curvature of the top end 68 of the block 64 extends in a direction that is generally parallel with the plane of the spade flange 50. This is further described below.

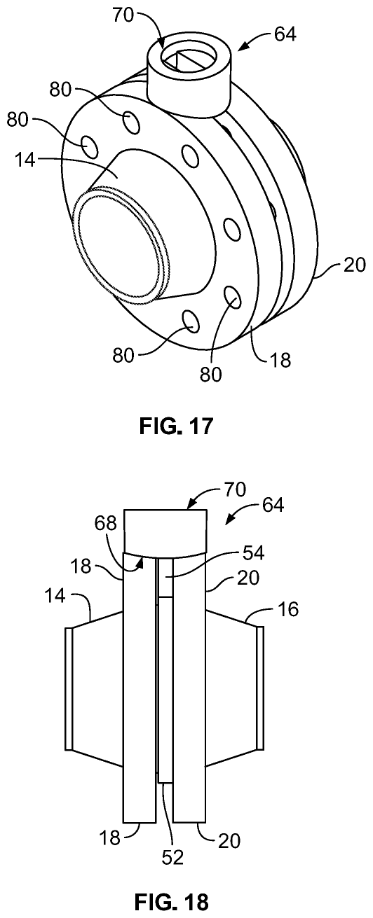

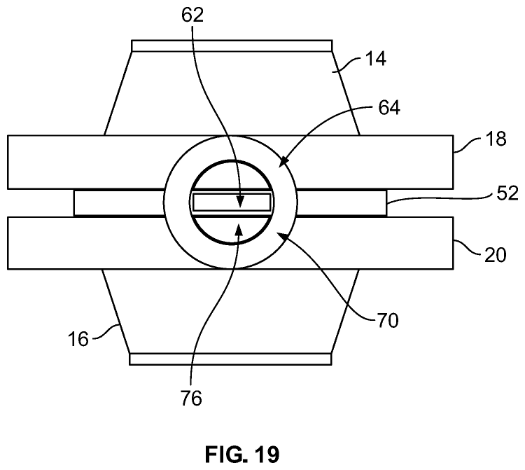

FIGS. 17-19 illustrate the spade device described herein when in use in a flanged connection. As shown, the spade flange 50, comprising the spade flange portion 52 and attachment block 64, are positioned between opposed flanges 18, 20 of the flanged connection. As described above, such positioning is achieved by removing the nuts and bolts securing the flanges together (as illustrated in FIGS. 1 and 3), separating the flanges 18 and 20, and inserting the spade flange portion 52 there-between. As will be appreciated, since the spade flange portion 52 generally comprises a flat, plate or disc shape, the flanges 18 and 20 need only be separated by a short distance. Generally, such distance need only be slightly greater than the thickness of the spade flange portion 52.

The positioning of the spade flange portion 52 is such that the opening between the two flanges 18 and 20 is completely blocked. As would be understood, for achieving this purpose, the outer diameter of the spade flange portion 52 would be sized to be greater than the outer diameter of the openings in each of the flanges 18 and 20.

In a preferred aspect, one or more sealing elements, such gaskets as known in the art, are provided between the spade flange portion 52 and one or both of the flanges 18, 20. In particular, at least one sealing element would preferably be provided between the flange and the first face 58 of the spade flange portion 52 having the well 56. For this purpose, it would be understood that the outer diameter of the spade flange portion 52 would extend beyond the outer diameter of the openings in the flanges 18 and 20 at least to a sufficient amount as to also overlap the one or more sealing elements provided between the spade flange portion 52 and one or both of the flanges 18, 20. It will be understood that, in this manner, a fluid seal is created between the spade flange portion 52 and the equipment being cleaned. Such an arrangement prevents leakage to and contamination of the ground at the site of the flange. It will be understood that the annulus formed between the outer diameter of the flange portion 52 and the well 56 provides a continuous sealing surface for engaging a gasket and an opposing flange face, as would be encountered in a regular flanged connection. This therefore establishes a sealed connection between the flanged connection and the equipment being cleaned (i.e. the equipment facing the first face 58 of the flange portion 52).

As described above, the first face 58 having the well 56 has a generally annular shape. This is preferred so as to accommodate gaskets that are typically also have an annular shape. However, in other aspects, it is possible for the first face 58 to have a well that is off center, wherein the first face would not necessarily have an annular shape. However, even in such arrangement, the perimeter of the first face 58 surrounding the well 56 would still have a continuous structure so as to form a seal with a gasket or the like.

As illustrated in FIGS. 17-19, and as would be understood, the outer diameter of the spade flange portion 52 would be less than the diameter of the boltholes 80 that would normally be provided on the flanges 18 and 20. In this way, the bolts (such as shown in FIGS. 1 and 3) could be inserted into the boltholes 80 without being impeded by the spade flange portion 52.

In addition, it will be understood that the handle portion 54 of the modified spade flange device 50 will extend outside of the diameter of the flanges 18, 20. It will also be understood that the width of the handle 54 would be less than the circumferential distance between adjacent bolts that secure the flanges together. In this way, the handle 54 extends radially outwards between two adjacent bolts and beyond the diameter of the flanges.

As mentioned above, top end 68 of the block 64 is provided with a curved surface, the plane of curvature of which is preferably generally parallel with the plane of the spade flange portion 52. As illustrated for example in FIGS. 17 and 18, such curvature of the top end 64 also preferably corresponds to the curvature of the edge of the flanges 18 and 20. In this way, the top end 68 of the block 64 is received on the curved edge of the flanges and is “seated” thereon. Similarly, the length of the handle portion 54 is preferably sized to allow the top end 68 of the block 64 to be so seated. As will be understood from the present description, seating the top end 68 of the block 64 to the flanges 18, 20 in this manner offers the advantage of preventing or reducing relative movement between the block 64 and the flanges.

As described above, the purpose of the modified spade device discussed herein is to allow a means of draining cleaning effluent resulting from a cleaning operation. In particular, when cleaning a vessel or other plant equipment, the flanged connection connecting the equipment to other equipment is dismantled by removing the nuts and bolts joining the flanges (such as 18 and 20 discussed above), and partially separating the flanges. The spade flange portion 52 of the present device is then inserted along with the seal or gasket as discussed above. The flanges are then connected together to re-form the flanged connection. Thereafter, the required cleaning fluid is injected or sprayed from an opening provided in the equipment at an opposite or away from the flanged connection. The cleaning fluid, after being introduced into the equipment, finally travels to the well 56 provided in the spade flange portion 52 and is subsequently diverted into the drain 62 in the handle portion 54.

As illustrated in FIGS. 7-9 and 16, the well 56 is preferably sized to occupy a significant surface area over the first face 58 of the spade flange portion 52. In a preferred embodiment, the well 56 has a generally circular profile that is concentric with the circularly shaped spade flange portion 52. With this arrangement, and as shown in FIGS. 7, 8, and 16, the first face 58 is provided with a generally annular disc-shaped geometry having an outer or major diameter, d1, generally consisting of the outer diameter of the spade flange portion 52, and an inner or minor diameter, d2, generally consisting of the outer diameter of the well 56. It will be understood that the width, w, of the annular ring forming the first face 58 will generally correspond to, or be greater than, the width of the gasket or sealing element that is provided between the spade flange portion 52 and the adjacent flange.

Once the waste effluent from the cleaning operation enters the well 56, it passes into the drain 62 provided in the handle portion 54 and then into the bore 72 of the connecting block 64. As discussed below, the connecting block is adapted to be connected to a disposal truck, which collects the waste effluent.

In one aspect, the bore 72 of the connecting block 64 is provided with a threaded inner diameter 74 as discussed above. Such threading is adapted to threadingly engage a threaded connecting element of a hose or the like, which in turn is connected to a disposal truck or other such transport means. Thus, with the device described herein, the waste effluent, after passing through the equipment being cleaned, is directly collected and retained in the disposal truck without any risk of spillage etc. that may contaminate or pollute the ground.

In the aspect described herein the connecting block 64 is adapted to receive the hose or the like of the disposal truck by means of cooperating threaded elements. However, it will be understood that any other means of sealing connection may be employed. For example, the connecting block 64 and the hose may be adapted to form any type of coupling there-between, such as a “Quick Connect” or a “Camlock” coupling etc. The present description is not limited to any particular coupling means between the connecting block and the hose.

As will be understood, the cleaning process for equipment as described above typically involves the use of pressurized cleaning fluid that is applied at a relatively high volumetric flow rate. Further the disposal truck may apply a vacuum to draw fluids through the present described spade flange device, which further increases the flow rate of the cleaning fluid through the spade flange device. The spade flange device described herein is therefore adapted to receive and efficiently divert or drain such cleaning fluid owing to the size of the well 56 and the maximized cross-sectional area of the drain 62.

These and other advantages of the spade flange device described herein were not achievable with previously known methods or devices. For example, although some spade flanges are known in the art to have a port, such port merely served to passively drain fluids that may accumulate on one side thereof, by gravity drainage. For this reason, the port provided on known devices comprises a very small diameter hole that was provided on the outer perimeter of the device, wherein the hole must be oriented at the lower most position. Such devices are not adapted to connect to disposal trucks and the like and are completely unable to allow the necessary volumetric flow rates that are needed for cleaning operations.

As will be understood from the present description, the modified spade flange described herein can be used when cleaning any type of equipment that is connected with flanged connections. These include, but are not limited to, reaction vessels, holding or storage tanks, conduits, etc.

In one aspect, the connecting block 64 may be provided with one or more of valves or gauges (not shown), such as a pressure gauge and/or a flow gauge. Such devices would be used to control and/or monitor the fluid flowing through the connecting block 64, and therefore the spade flange device 78. As will be understood, a valve would enable attachment and detachment of the hose etc. connected to the fluid disposal truck. It will be understood, however, that such valves and/or gauges may be provided on the disposal truck itself.

In the above description, the spade flange 50, and spade flange device 78 (i.e. the combination of the spade flange 50 and the connecting block 64) has been described in terms of allowing cleaning fluids to be removed in a safe and efficient manner from equipment being cleaned. However, in view of the seal formed between the flange 50 and the flanged connection, it will be understood that the device 78 can also be used to inject fluids into the equipment in question. For example, in one aspect, the spade flange device 78 described herein may be used to pressurize equipment, such as a vessel, conduit, etc., by sealing such equipment, connecting the spade flange device 78 as described herein, and injecting pressurized fluid though such device 78. In this way, the equipment can be pressurized to test its integrity, thereby providing an efficient means of conducting a hydrostatic test of the equipment. Upon completion of the test, the fluid used to pressurize the equipment can be drained through the spade flange device 78. If necessary, the device 78 can be maintained in place and a cleaning operation can be conducted as described above by introducing a cleaning fluid through an opening in the equipment.

Although the above description includes reference to certain specific embodiments, various modifications thereof will be apparent to those skilled in the art. Any examples provided herein are included solely for the purpose of illustration and are not intended to be limiting in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all prior art recited herein are incorporated herein by reference in their entirety.

1. A spade flange tool comprising:
a generally disc shaped spade portion having a diameter and a radially extending handle;
a connecting block connected to the handle;
the spade portion having a first face and a second face, the first face including a well, the well having a diameter that is less than the diameter of the spade portion;
the handle including a drain extending there-through, the drain being in fluid communication with the well;
the connecting block having a first end having an aperture adapted to receive the handle, and an opposed second end, having a bore, the bore being in fluid communication with the drain.

2. The spade flange tool of claim 1, wherein the first face of the spade portion comprises a generally annular shape bounded by the diameter of the well and the diameter of the spade portion.

3. The spade flange tool of claim 1, wherein the handle comprises a generally rectangular shaped body.

4. The spade flange tool of claim 3, wherein the drain comprises a generally rectangular shaped orifice.

5. The spade flange tool of claim 1, wherein the connecting block is permanently attached to the handle.

6. The spade flange tool of claim 1, wherein the connecting block first end is provided with a curvature, and wherein the curvature is generally parallel with a plane of the spade portion.

7. The spade flange tool claim 1, wherein the connecting block is adapted for connection to a collection hose.

8. The spade flange tool of claim 1, wherein the bore of the connecting block is adapted for connection to a collection hose.

9. The spade flange tool of claim 8, wherein the bore of the connecting block is provided with a thread for forming a threaded connection with the collection hose.

10. The spade flange tool of claim 1, wherein the connecting block is adapted for connection to a valve, a pressure gauge, and/or a flow gauge.

11. A method of draining equipment having a flanged connection comprising:
providing a spade flange tool according to claim 1;
connecting the spade flange tool to the flanged connection, wherein the tool is positioned between opposed flanges of the flanged connection;
introducing a fluid into the equipment;
draining the fluid through the tool.
